(19) United States
(12) Patent Application Publication
(10) Pub. No.: US 2005/0152264 A1
(43) Pub. Date: Jul. 14, 2005

(54) Ultra-wideband data communication system with diversity transmit and receive feature

(76) Inventor: Kazimierz Siwiak, Coral Springs, FL (US)

Correspondence Address: Steven A. Moore;PULSE-LINK, INC., 1969 Kellogg Avenue, Carlsbad, CA, 92008, US

(21) Appl. No.: 10/974,038

(22) Filed: Oct. 26, 2004

Related U.S. Application Data
(60) Provisional application No. 60/535,268, filed on Jan. 9, 2004.

(51) Int. Cl. H04J 11/00; H04J 1/00

(52) U.S. Cl. 370/206

(57) ABSTRACT

A high capacity wireless ultra-wideband (UWB) data communication system includes a transmitter having a signal generator for supplying UWB signals and a receiver for receiving the UWB signals. In one embodiment, the system also includes at least two antennas at the transmitter and/or at the receiver. The transmit antennas are configured so that the cross-correlation between their emissions is sufficiently low that reception of the signals is substantially improved. The receive antennas likewise exhibit low cross-correlation.

### CROSS-REFERENCE TO RELATED APPLICATIONS

This patent application claims priority to, and incorporates by reference, provisional U.S. patent application Ser. No. 60/535,268, Attorney Docket No. DDT002, filed on Jan. 9, 2004.

### BACKGROUND

The disclosures herein relate generally to communication systems and more particularly to wireless ultra-wideband (UWB) data communication systems.

The proliferation of wireless communication devices in unlicensed spectrum (such as in the 915 MHz, and 2.4 GHz ISM bands and the 5 GHz UNII bands), and the ever increasing consumer demands for higher data bandwidths have placed a severe strain on these frequency spectrum bands. New devices and new standards are continually emerging, such as the IEEE 802.11b, IEEE 802.11a, IEEE802.11g, IEEE 802.11n, IEEE 802.15.3, HiperLAN/2 standards, for example. These new devices and standards are placing an additional burden on those frequency bands. Coexistence among the many communications systems is taking on an increasing level of importance as consumer devices proliferate.

It is also well known that the available data bandwidth and capacity of wireless systems is constrained by the available bandwidth of the license-free bands. Data rate throughput capability varies proportionally with available bandwidth, but only logarithmically with available signal to noise ratio. Hence, to accommodate high capacity systems within a constrained bandwidth requires the use of complex signal modulation technologies which need significantly increased signal to noise ratios, making the higher data rate systems more fragile and more easily susceptible to interference from other users of the spectrum. Moreover, these complex modulation technologies are also highly susceptible to multipath interference thereby aggravating the coexistence concerns. Furthermore, regulatory limitations within the license-free bands constrain the maximum available signal to noise ratio. Increasingly, the cost of devices becomes critically important as device use permeates an increasingly larger consumer base. That consumer base includes more and more devices that are small, have small batteries, and have small demands on power.

What is needed is a high data capacity wireless communication system that can readily coexist with other existing wireless communication systems operating in the license-free bands, that can operate at moderate data dates, that can be scaled to expand data rate capability very easily, that can be easily embedded in host devices, that has suppressed energy emission characteristics outside the desired bands, and that consumes small amounts of energy from the host device.

### SUMMARY

Accordingly, in one embodiment, a method of communicating is disclosed including transmitting an ultra-wideband signal having first and second signal components exhibiting diversity. The method also includes receiving the ultra-wideband signal by combining the first and second signal components to provide a diversity gain. The method further includes supplying the first and second signal components respectively to first and second antennas which exhibit a low cross-correlation therebetween at a transmit end of a communication link. Antennas similar to the first and second antennas are employed at the receive end of the communication link to receive the first and second signal components to realize a diversity gain.

In another embodiment, a communication system is disclosed that includes a transmitter that transmits an ultra-wideband signal including first and second signal components exhibiting diversity. The system also includes a receiver that receives the ultra-wideband signal by combining the first and second signal components to provide a diversity gain. The transmitter is coupled to first and second antennas to which the first and second signal components are supplied at a transmit end of a communication link. The first and second antennas exhibit a cross-correlation that is relatively low. Antennas similar to the first and second antennas are employed at a receive end of the communication link to help receive the first and second signal components to realize a diversity gain.

### BRIEF DESCRIPTION OF THE DRAWINGS

FIG. 1 is a graph showing the cumulative distribution function (CDF) of signal strength for signals of various instantaneous bandwidths.

FIG. 2 is a graph showing the corresponding probability distribution function (PDF) for the 4 MHz and 1400 MHz signals of FIG. 1.

FIG. 3 as a block diagram of the transmitter portion of a transceiver at one end of a communications link and the receiver portion of a transceiver at the other end of the link in the disclosed communication system.

FIG. 4 is an antenna configuration employing polarization diversity that is used in one embodiment of the disclosed communication system.

FIG. 5 is an antenna configuration employing spatial diversity that is used in another embodiment of the disclosed communication system.

FIG. 6 is an antenna configuration employing left and right rotation diversity that is used in another embodiment of the disclosed communication system.

FIG. 7 is a block diagram of one embodiment of the disclosed communication system.

FIG. 8 is a block diagram of another embodiment of the disclosed communication system.

### DETAILED DESCRIPTION

With the advent of the FCC ruling permitting ultra-wideband (UWB) emissions, many UWB transmission and reception systems have been proposed. The FCC ruling does not define UWB, but instead describes a UWB transmitter as one whose emissions are at least 500 MHz wide as measured between points 10 dB down from the peak emission, and operating in the 3.1 to 10.6 GHz spectrum at an effective isotropic radiated power (EIRP) level below −41.3 dBm/MHz. This broad regulatory definition effectively does not in itself prohibit conventional radio technologies like the well known Orthogonal Frequency Division Multiplexing (OFDM) system from qualifying as “UWB” under the rules. Such OFDM solutions have been proposed as UWB solutions in the IEEE 802 project 802.15.3a.

One such OFDM system employs 128 carriers or tones, of which 122 are actually transmitted, spaced at 4.125 MHz intervals. The problem with such an OFDM type of “UWB” solution is that to a receiver of such a signal, the receiver bandwidth is effectively approximately 4 MHz per carrier. This means that signal is subjected to nearly full Rayleigh fading, which has a large effect on the link margin, perhaps in the range of approximately 6 dB. High data rate UWB systems of the OFDM type can not afford such a substantial link margin “hit”. Hence a solution is needed that preferably does not experience significant Rayleigh fading.

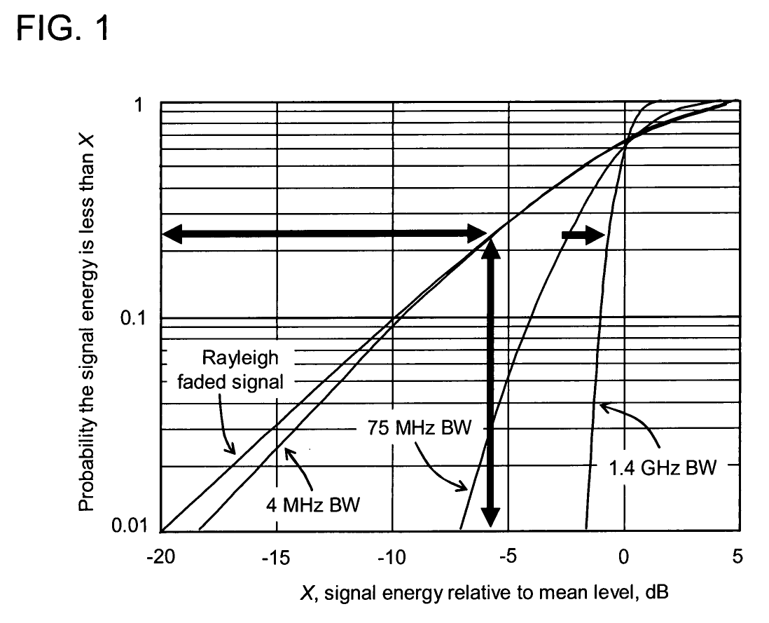

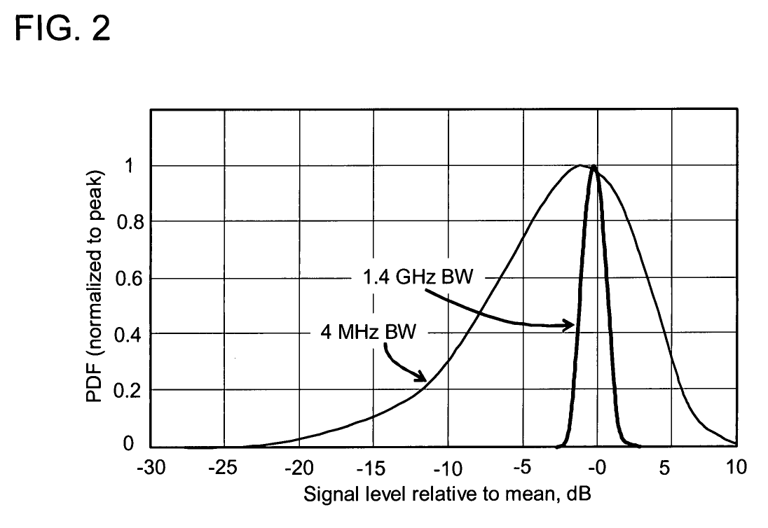

Conventional true UWB impulse signal radios do not encounter Rayleigh fading because the impulse signals of such radios do not persist long enough in time to encounter the constructive and destructive interference that narrow band OFDM signals, which persist for comparatively long times, encounter. FIG. 1 shows the cumulative distribution function (CDF) of signal strength for signals of various instantaneous bandwidths, namely 4 MHz, 75 MHz and 1.4 GHz. FIG. 2 shows the corresponding probability distribution function (PDF) for the 4 MHz and 1.4 GHz signals. The 4 MHz curves of FIGS. 1 and 2 are representative of the performance of a conventional OFDM type of UWB system, since each of the “tones” or “carriers” is effectively viewed through a 4 MHz wide filter during the reception of an OFDM waveform. In particular, the 4 MHz curve has a very wide distribution as seen in FIG. 2. A large percentage of the OFDM signal is distributed well below the median or 0 dB level. At least 25% of the signal is 6 or more dB below the median and at least 10% of the signal is at least 10 dB below the median level. The consequence is that there is a huge frequency selective fading component that can render a large number of the OFDM carriers ineffective because of multipath distortion. This can easily swamp the effectiveness of error correction codes. Since much of the fading is due to a relatively static environment, encoding the OFDM signals in time does not help very much. In comparison, a true UWB system employing 1.4 GHz wide impulses has a tight signal distribution and does not encounter this fading or multi-path loss.

A high capacity UWB transmitting and receiving system of the OFDM type is disclosed which exhibits substantially less multi-path loss than conventional OFDM type UWB solutions. Briefly, the disclosed communication system includes a UWB transmitter for transmitting data through a UWB antenna system coupled thereto. The system also includes a receiver with a UWB antenna system at the other end of a data link formed between the transmitter and receiver. The UWB antennas are configured so that signals are transferred using diversity transmission over the link from transmitter to receiver. The UWB antennas on both ends of the link are configured so that emissions from the transmitter when received by the receiver exhibit sufficiently low cross-correlation that they produce a diversity gain improvement at the receiver. The cross-correlation of two signals is defined as the integral of the product of the two signals divided by the product of their RMS (root mean square) values. In one embodiment of the disclosed system, values of cross-correlation below about 0.7 are deemed sufficiently low for diversity improvement. It is noted that values of cross correlation more that 0.7 may also produce acceptable results as long as the multipath conditions are less than full Raleigh fading.

The diversity gain improvement can be achieved by transmitting and receiving on 2 polarizations and/or by antennas having spatial separation and/or by antennas that are sensitive to each of two different field components such as the electric field and the magnetic field. For example, a dipole is primarily sensitive to the electric filed while a loop antenna is sensitive primarily to the magnetic field. The electric and magnetic fields of a signal are generally uncorrelated in multipath. The diversity improvement can be obtained by having diversity antennas at the receiver end of the link, or at the transmitter end of the link or at both ends of the link. Thus, in one embodiment, a two-way link may be configured with the benefit of diversity improvement in both link directions, yet the diversity complexity of multiple antennas is entirely at one end of the link

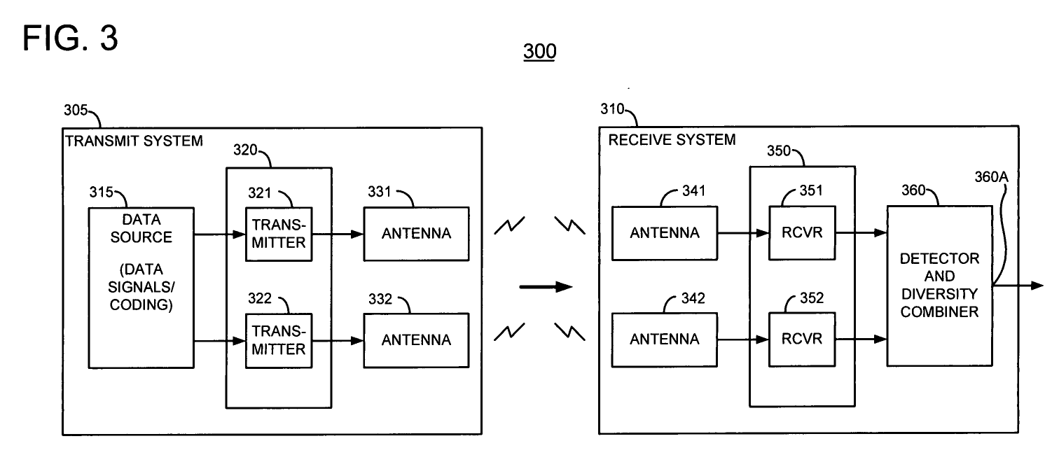

In FIG. 3, a UWB diversity communication system 300 is disclosed to help mitigate the multi-path or Rayleigh fading signal loss typically encountered by OFDM type UWB systems. The disclosed UWB diversity system includes an OFDM UWB transceiver (transmitter/receiver) at one end coupled by a link to an OFDM UWB transceiver (transmitter/receiver) at the other end. For simplicity however, in FIG. 3, an OFDM UWB transmit system 305 at one end of the link and an OFDM UWB receive system 310 at the other end of the link are shown and discussed. Transmit system 305 includes a data source 315 that supplies a data stream to transmit stage 320. Transmit stage 320 includes two substantially identical transmitters 321 and 322. In this particular OFDM UWB diversity system 300, a UWB transmit stage 320 feeds at least two antennas 331 and 332 that are decoupled or exhibit low cross correlation. For purposes of this document, low cross correlation includes zero cross correlation such as found in completely decoupled antennas.

The receive system 310 of the corresponding transceiver at the receive end of the link employs diversity antennas 341 and 342 that are decoupled or exhibit low cross correlation similar to the manner of antennas 331 and 332 discussed above. Receive system 310 includes a receive stage 350. In this embodiment, receive stage 350 includes one receiver for each receive antenna. Thus, receive stage 350 includes receivers 351 and 352 that are coupled to antennas 341 and 342, respectively. Receivers 351 and 352 are coupled to a detector and diversity combiner 360 that monitors the signal outputs of receivers 351 and 352 and determines how the signals are selected or weighted and combined. In “selection diversity”, detector/combiner 360 selects the higher quality signal of the two signals provided thereto and then employs the selected signal as the receive signal. The selected receive signal is supplied as a data stream to output 360A. In “combining diversity”, the signals are weighted and combined in an optimal method such as “equal gain combining” or “maximal ratio combining”, for example. Equal gain combining and maximum ratio combining are combining diversity methods known in the art. The data stream thus retrieved is provided to output 360A and may be supplied to other stages for further handling, depending on the particular application.

It is noted that whatever coding scheme is used to encode data signals at data source 315, the corresponding decoding methodology is employed in detector and diversity combiner 360 to provide the retrieved data stream. For example, if IEEE 802.15 standard coding is used in data source 315 of transmit system 305, then IEEE 802.15 standard decoding is used in detector and diversity combiner 360 of receive system 310. In more detail, such coding and decoding includes the appropriate application layer, logic link control (LLC) layer and media access control (MAC) layer of the particular standard employed.

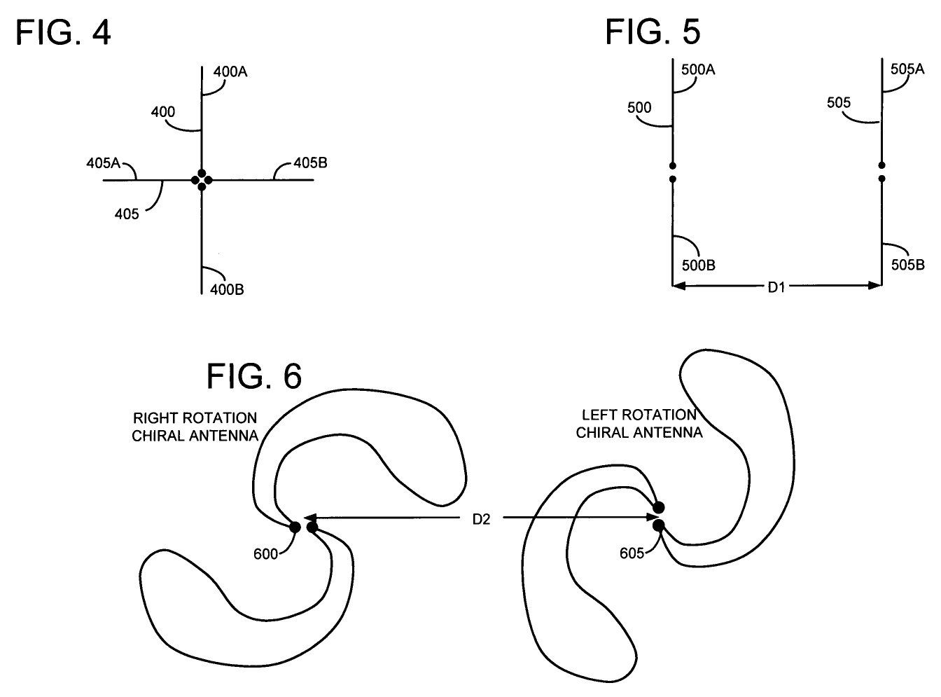

FIGS. 4, 5 and 6 show different antenna configurations that may be used to achieve diversity gain in communication system 300. Each of these antenna configurations provides the desired decoupled or low cross correlation antenna properties needed to provide such diversity gain. Other antenna configurations may be employed in addition to the particular examples given provided such other antenna configurations provide low cross correlation among multiple antennas.

FIG. 4 is an antenna array configured to provide polarization diversity. The antenna array of FIG. 4 includes two orthogonally polarized dipole antennas 400 and 405 with adjacent or co-located feed points. Antenna 400 includes dipole elements 400A and 400B which transmit a vertically polarized signal when employed as antenna 331 of transmit system 305 of FIG. 3, and which receive a vertically polarized signal when employed as antenna 341 of receive system 310 of FIG. 3. Returning to FIG. 4, antenna 405 includes elements 405A and 405B that transmit a horizontally polarized signal when employed as antenna 332 of transmit system 305 of FIG. 3, and which receive a horizontally polarized signal when employed as antenna 342 of receive system 310 of FIG. 3. In this polarization diversity antenna arrangement, two orthogonal polarizations are transmitted and two orthogonal polarizations are received to provide diversity gain. It is noted that in an alternative embodiment, a signal may be transmitted using one polarization with reliance on the environment to scatter energy to produce an orthogonal polarization. In such an embodiment, only one antenna is needed on the transmit end of the link while two diversity antennas will be employed at the receive end of the link to capture signals from each polarization. Combiner 360 optimally selects or combines the received signals as described above.

FIG. 5 is an antenna array that is configured to provide spatial diversity between two wide band dipoles 500 and 505. Dipoles 500 and 505 are vertically polarized but spatially separate to achieve diversity or decoupling therebetween. More particularly, dipoles 500 and 505 are spaced apart by a distance, D1, which is sufficiently large to provide low cross correlation between the two antennas. In one embodiment, distance D1 is approximately ⅓ of a wavelength of the lower UWB band edge frequency to provide the desired diversity effect. Antenna 500 includes dipole elements 500A and 500B which transmit a vertically polarized signal when employed as antenna 331 of transmit system 305 of FIG. 3, and which receive a vertically polarized signal when employed as antenna 341 of receive system 310 of FIG. 3. Returning to FIG. 4, antenna 505 includes elements 505A and 505B that transmit a vertically polarized signal when employed as antenna 332 of transmit system 305 of FIG. 3, and that receive a vertically polarized signal when employed as antenna 342 of receive system 310 of FIG. 3. In this spatial diversity antenna arrangement, two spatially diverse signals are transmitted and two spatially diverse polarizations are received. Detector/combiner 360 again selects the signal of the two which exhibits the higher signal quality or combines the signals using one of the optimal combining techniques described above. In another embodiment, antennas 331 and 332 may be horizontally polarized but spatially separate, and antennas 341 and 342 may likewise be horizontally polarized but spatially separate.

FIG. 6 depicts an antenna array including an antenna 600 that is configured to generate a radiation pattern with a right rotation and an antenna 605 which is configured to generate a radiation pattern with a left rotation. Left and right chiral antennas 600 and 605 as depicted in FIG. 6 can be used to generate such radiation patterns when employed as antennas 331 and 332, respectively, on the transmit end of the link (FIG. 3) and when employed as antennas 341 and 342, respectively, on the receive end of the link (FIG. 3). The right and left rotation antennas exhibit low cross-correlation therebetween and thus provide the diversity gain discussed above.

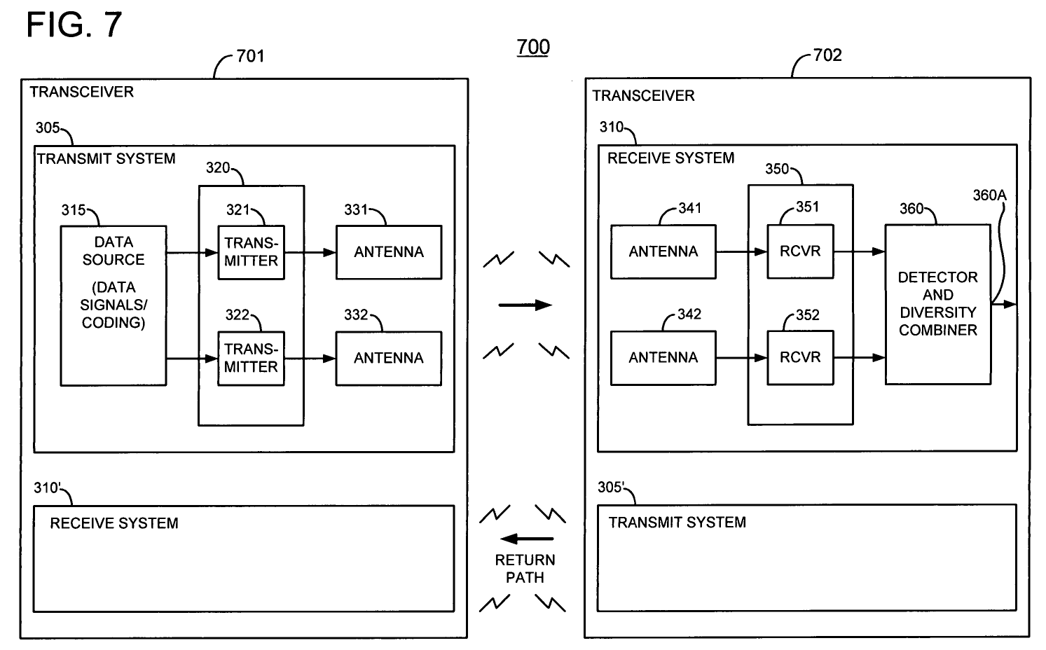

FIG. 7 shows a more detailed block diagram of the disclosed communication system as system 700. Communication system 700 includes transceivers 701 and 702 which are configured to transmit and receive RF signals therebetween. At one end of the link, transceiver 701 includes a transmit system 305, shown previously in FIG. 3, and a receive system 310′ similar to receive system 310 that was also shown previously in FIG. 3. Transmit system 305 and receive system 310′ are thus co-located. At the other end of the link, transceiver 702 includes a transmit system 305′ similar to transmit system 305, shown previously in FIG. 3, and a receive system 310 shown previously in FIG. 3. Receive system 310 and transmit system 305′ are co-located. Antennas 331, 332, 341 and 342 may be any of the antenna configurations shown in FIGS. 4, 5 and 6, or other antenna configurations which exhibit low cross correlation between antennas pairs. Examples of antenna pairs are antenna pair 331, 332, and antenna pair 341, 342.

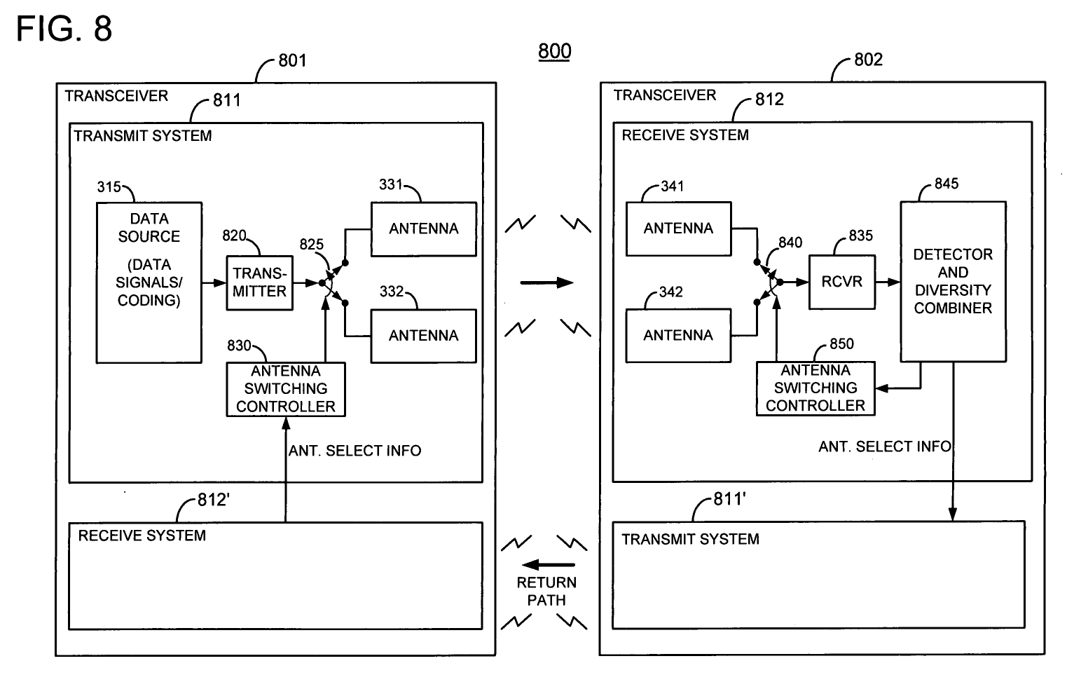

FIG. 8 is a block diagram of another embodiment of the disclosed communication system, namely system 800. Communication system 800 includes several components in common with communication system 700 of FIG. 7. Like numbers are used to indicate like components in these figures. In more detail, communication system 800 includes a transceiver 801 at one end of a link and a transceiver 802 at the other end of the link. Transceiver 801 and 802 respectively include a transmit system 811 and a corresponding receive system 812 as shown. Transceiver 801 further includes a receive system 812′ which is similar to receive system 812 except that receive system 812′ is employed in the return path. Transceiver 802 further includes a transmit system 811′ which is similar to transmit system 811 except that transmit system 811, is employed in the return path. Transmit system 811 communicates with receive system 812 and transmit system 811′ communicates with receive system 812′.

In system 800 of FIG. 8, data source 315 supplies a digital data stream to an OFDM type UWB transmitter 820, the output of which is switchably coupled by antenna switch 825 to antennas 331 and 332 which exhibit low cross correlation therebetween. Antenna switch 825 couples transmitter 820 to either antenna 331 or 332 depending on which antenna provides a better quality signal to receive system 812 of transceiver 802. Transmit system 811 includes an antenna switching controller 830 which is coupled to antenna switch 825 to instruct which antenna should be connected to transmitter 820. The mechanism for selecting the particular antenna 331 or 332 is discussed in more detail below. When communication is initiated between transceivers 801 and 802, controller 830 alternatingly switches between antennas 331 and 332 to permit circuitry in receive system 812 to determine which antenna results in better reception thereby. This antenna selection information (ANT. SELECT INFO), namely which of antennas 331 and 332 provides better results, is communicated back to antenna switching controller 830 of transceiver 801 by the link between transmit system 811′ of transceiver 802 to receive system 812′ of transceiver 801. Using the antennas selection information, controller 830 instructs antenna switch 825 to connect transmitter 820 to the particular antenna 331 or 332 which provides better results.

The signal transmitted by transmit system 811 is received at receive system 812 via antenna pair 341, 342. Antennas 341 and 342 are switchably coupled to receiver 835 by an antenna switch 840 therebetween. Receiver 835 is coupled to a detector and diversity combiner 845 which receives the incoming signal from receiver 835. Detector/combiner 845 is coupled to an antenna switching controller 850 that is coupled to antenna switch 840 so that detector combiner 845 can determine which antenna 341 or 342 results in a higher quality received signal. Under the direction of detector/combiner 845, controller 850 instructs antenna switch 840 to alternatingly switch between antenna 341 and 342 until detector/combiner 845 determines which antenna results in the superior quality received signal. The antenna controller 850 then causes antenna switch 840 to couple the particular one of antennas 341 and 342 which provides a better signal to receiver 835. In yet another embodiment, the functionality of antenna switching controller 850 can be included in detector/combiner 845.

More detail is now provided with respect to the operation of antenna switching controller 830 and antenna switch 825 in transmit system 811. When communication is initiated between transceivers 801 and 802, switching controller 830 of transceiver 801 alternatingly switches between antennas 331 and 332. During this switching time, detector/combiner 845 of transceiver 802 listens to the signals it receives to determine which of antennas 331 and 332 results in the higher quality received signal. Once this is determined, detector/combiner 845 sends antenna selection information (ANT. SELECT INFO) to transceiver 801 over a return path provided by transmit system 811′ of transceiver 802 and receive system 812′ of transceiver 801. Antenna switching controller 830 is supplied with this antenna selection information, and in response, controller 830 then connects transmitter 820 to the particular one of antennas 331 and 332 indicated as providing a better signal by the antenna selection information.

The disclosed OFDM type UWB communication system mitigates the impact of multipath fading by transmitting and receiving with UWB antennas having two orthogonal polarizations, or two spatially separated antennas, or a pair of left and right handed chiral polarization antennas in the illustrated embodiments. Uncorrelated or low cross correlation diversity signals are thus generated which are captured by diversity antennas and combined in a receiver to provide diversity gain. The diversity technique can be “combining diversity” wherein the signals having low cross correlation are weighted and combined in an embodiment such as depicted in FIG. 7. The diversity technique can also be “switched diversity” as in FIG. 8 wherein a single receiver is fed by two (or more) low cross correlation or uncorrelated antennas selected by a switch, and/or combining diversity wherein either the outputs of separate receivers are combined, or the channel equalized outputs from antennas in each of the diversity paths are combined in a single receiver. In summary, the disclosed communication system provides multiple ways to receive information and these multiple ways are uncorrelated or exhibit low cross correlation. Effectively at least 2 diversity channels are provided that are uncorrelated or exhibit low cross correlation. The effect of multi-path is thus dramatically reduced in the disclosed communication system since if one antenna has a signal of low quality, another antenna exhibiting a higher quality signal may be available.

Although illustrative embodiments have been shown and described, a wide range of modification, change and substitution is contemplated in the foregoing disclosure and in some instances, some features of an embodiment may be employed without a corresponding use of other features. For example, while transceiver 701 has two transmit antennas, 331,332 in transmit system 315 and two receive antennas in receive system 310′, an embodiment is possible where transmit system 305 and receive system 310′ share the same two antennas. Similar antenna sharing can be employed in transceiver 702. Accordingly, it is appropriate that the appended claims be construed broadly and in manner consistent with the scope of the embodiments disclosed herein.

1. A method of wireless communication comprising:
transmitting an ultra-wideband signal including first and second signal components exhibiting diversity; and
receiving the ultra-wideband signal by combining the first and second signal components to provide a diversity gain.

2. The method of claim 1 wherein the transmitting is performed at a first end of a wireless communication link and the receiving is performed at a second end of the wireless communication link.

3. The method of claim 1 wherein transmitting comprises supplying the first and second signal components to first and second antennas.

4. The method of claim 3 wherein the first and second antennas exhibit low cross-correlation.

5. The method of claim 1 wherein the first and second signal components are OFDM.

6. The method of claim 3 wherein receiving includes capturing the first and second signal components using third and fourth antennas, respectively.

7. The method of claim 6 wherein the first and second antennas exhibit vertical and horizontal polarization, respectively.

8. The method of claim 6 wherein the third and forth antennas exhibit vertical and horizontal polarization, respectively.

9. The method of claim 6 wherein the first and second antennas exhibit spatial diversity.

10. The method of claim 6 wherein the third and forth antennas exhibit spatial diversity

11. The method of claim 6 wherein the first and second antennas exhibit right and left chiral rotation, respectively.

12. The method of claim 6 wherein the third and forth antennas exhibit right and left chiral rotation, respectively.

13. The method of claim 3 further comprising switching between the first and second antennas to determine which of the first and second antennas provides a higher quality signal.

14. The method of claim 6 further comprising switching between the third and fourth antennas to determine which of the third and fourth antennas provides a higher quality signal.

15. A method of wireless communication with a transceiver comprising:
transmitting, by the transceiver, an ultra-wideband signal including first and second signal components exhibiting diversity; and
receiving, by the transceiver, an ultra-wideband signal by combining the third and fourth signal components exhibiting diversity to provide a diversity gain.

16. The method of claim 15 wherein the transmitting and the receiving is performed at one end of a communication link.

17. The method of claim 15 wherein the first and second signal components exhibit low cross correlation.

18. The method of claim 15 wherein the third and fourth signal components exhibit low cross correlation.

19. A wireless communication system comprising:
a transmitter which transmits an ultra-wideband signal including first and second signal components exhibiting diversity; and
a receiver that receives the ultra-wideband signal by combining the first and second signal components to provide a diversity gain.

20. The communication system of claim 19 wherein the transmitter is located at a first end of a wireless communication link and the receiver is located at a second end of the wireless communication link.

21. The communication system of claim 19 wherein the transmitter is coupled to first and second antennas to which the first and second signal components are supplied.

22. The communication system of claim 21 wherein the first and second antennas exhibit low cross-correlation.

23. The communication system of claim 19 wherein the first and second signal components are OFDM.

24. The communication system of claim 21 including third and fourth antennas, coupled to the receiver, that capture the first and second signal components, respectively.

25. The communication system of claim 24 wherein the first and second antennas exhibit vertical and horizontal polarization, respectively.

26. The communication system of claim 24 wherein the third and forth antennas exhibit vertical and horizontal polarization, respectively.

27. The communication system of claim 24 wherein the first and second antennas exhibit spatial diversity.

28. The communication system of claim 24 wherein the third and forth antennas exhibit spatial diversity

29. The communication system of claim 24 wherein the first and second antennas exhibit right and left chiral rotation, respectively.

30. The communication system of claim 24 wherein the third and forth antennas exhibit right and left chiral rotation, respectively.

31. The communication system of claim 24 wherein the receiver further comprises receiver circuitry that switches between the third and fourth antennas to enable a determination with respect to which of the third and fourth antennas provides a higher quality signal.

32. The communication system of claim 24 wherein the transmitter further comprises transmitter circuitry that switches between the first and second antennas to enable a determination with respect to which of the first and second antennas provides a higher quality signal.

33. A wireless communication transceiver comprising:
a transmitter that transmits an ultra-wideband signal including first and second signal components exhibiting diversity; and
a receiver that receives an ultra-wideband signal including third and fourth signal components which exhibit diversity to provide a diversity gain.

34. The method of claim 33 wherein the transmitter and receiver are co-located at one end of a communication link.

35. The communication transceiver of claim 33 wherein the first and second signal components exhibit low cross correlation.

36. The communication transceiver of claim 33 wherein the third and fourth signal components exhibit low cross correlation.
